(19) United States
(12) Patent Application Publication
(10) Pub. No.: US 2026/0016029 A1
(43) Pub. Date: Jan. 15, 2026

(54) DUCT STRUCTURE HAVING GUIDE VANE

(71) Applicants: KOREA WESTERN POWER CO., LTD., Chungcheongnam-do (KR); Seoul National University R&DB Foundation, Seoul (KR)

(72) Inventors: Won Tae HWANG, Seoul (KR); Joung Ho HAN, Gwangju (KR); Han June PARK, Seoul (KR); Kyu Ho HAN, Seoul (KR); Woong Chul CHOI, Incheon (KR); Jeong Mo SEONG, Gyeonggi-do (KR); Sang Eun BIN, Seoul (KR); Jun Hyung HONG, Gyeonggi-do (KR); Min Seung HWANG, Incheon (KR); Seong Yeop KIM, Chungcheongnam-do (KR); Yeon Kyung NAM, Chungcheongnam-do (KR); Doo Hyun BAEK, Chungcheongbuk-do (KR)

(21) Appl. No.: 18/773,246

(22) Filed: Jul. 15, 2024

(51) Int. Cl. F15D 1/04; B03C 3/011

(52) U.S. Cl. CPC F15D 1/04; B03C 3/011

(57) ABSTRACT

According to an aspect of the present invention, there is a duct structure having a guide vane according to one embodiment of the present invention for achieving the above-described objectives, including an inlet part through which exhaust gas discharged from a power generation apparatus is suctioned, a duct body which extends from the inlet part, guides a flow of the exhaust gas, and includes at least one curved portion, and a discharge part extending from the duct body and connected to an electrostatic precipitator, wherein the duct body further includes a first guide vane disposed at the inlet part to guide an inflow direction of the exhaust gas and a second guide vane disposed at the discharge part to guide a discharge direction of the exhaust gas, wherein the first guide vane and the second guide vane are disposed in the duct body.

### BACKGROUND

### 1. Field of the Invention

The present invention relates to a duct structure having a guide vane, and more particularly, to a duct structure having a guide vane which is disposed at an entrance of an electrostatic precipitator to implement a uniform flow distribution in duct so that an exhaust gas is uniformly supplied to the electrostatic precipitator.

### 2. Discussion of Related Art

Electrostatic precipitators (ESPs) are dust-removing apparatuses which separate dust from gas using electrostatic force by generating a corona using a DC high voltage to charge particles in the gas, are divided into dry, wet, and hybrid type ESPs, and have developed sequentially according to technological advancement.

Doosan Energy & Power Co., Ltd, which is one of the companies that develop electrostatic precipitators, has both dry and wet electrostatic precipitating technologies, and has reached a fine dust removal rate of a dry electrostatic precipitator of 99% and an ultrafine dust removal rate of 95%. In addition, when the wet electrostatic precipitating technology is applied, an ultrafine dust removal rate can be improved to 96 to 99%.

Meanwhile, as environmental regulations have recently been strengthened worldwide, increasing pollutant reduction efficiency has become very important. For reference, the Ministry of Environment has confirmed an action plan to reduce ammonia, ozone, NOx, and SOx involved in an ultrafine dust generation mechanism through the “Fine Dust Management Comprehensive Plan (2020 to 2024).” Particularly, the action plan includes reducing ultrafine dust emissions from coal-fired power plants by 25% or more through the early retirement of old coal-fired power plants and an increase in investment in environmental facilities in the power generation sector.

In this situation, the capacity of environmental facilities to reduce pollutant emissions has been increased in each power plant, but there is a problem that a budget is high (100 billion won) and a construction period for the environmental facilities is long (6 months/one facility). In addition, addition of lands for apparatus and structural changes according to installation are required, and complex administrative procedures are entailed due to an expense process.

In this situation, a more efficient solution is to improve the performance of a currently operating precipitator, which can be achieved through uniformization of an internal gas flow.

### SUMMARY OF THE INVENTION

The present invention is invented to solve the above-described problems and directed to providing a duct structure capable of uniformizing an exhaust gas flow. According to an aspect of the present invention, there is a duct structure having a guide vane according to one embodiment of the present invention for achieving the above-described objectives, including an inlet part through which exhaust gas discharged form a power generation apparatus is suctioned, a duct body which extends from the inlet part, guides a flow of the exhaust gas, and includes at least one curved portion, and a discharge part extending from the duct body and connected to an electrostatic precipitator, wherein the duct body further includes a first guide vane disposed at the inlet part to guide an inflow direction of the exhaust gas and a second guide vane disposed at the discharge part to guide a discharge direction of the exhaust gas, wherein the first guide vane and the second guide vane are disposed in the duct body.

In addition, the first guide vane may include a curved vane curved along an orientation of the curved portion and a straight vane extending from a front end or rear end of the curved vane.

In addition, the first guide vane may be disposed from the inlet part to the duct body at the inlet part.

In addition, a straight length of the straight vane at a front end of the first guide vane may be ½ or less of a width (D) of the inlet part, and a straight length of the straight vane at a rear end of the first guide vane may be ½ or less of the width (D) of the inlet part.

In addition, the first guide vane may be located between ⅕D in a left direction and ⅕D in a right direction from a center of the duct body in a width direction, and two cross-sectional areas divided from the duct body at the front end of the first guide vane in the width direction and two cross-sectional areas divided from the duct body at the rear end of the first guide vane in the width direction may be substantially the same.

In addition, the second guide vane may be disposed from the discharge part to the duct body at the discharge part, and the second guide vane may be provided as a pair of second guide vanes in each discharge part.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1A is a conceptual view illustrating a precipitator to which a duct structure having a guide vane according to one embodiment of the present invention is applied;

FIG. 1B is a cross-sectional view illustrating the duct structure including the guide vane according to one embodiment of the present invention along line A-A in

FIG. 1A;

FIG. 2 is a cross-sectional view along line B-B and line C-C in FIG. 1B; and

FIG. 3A shows experimental data obtained by analyzing a flow in a duct structure according to a comparative example using computational fluid dynamics (CFD), and FIG. 3B shows experimental data obtained by analyzing a flow in the duct structure according to a shape of the guide vane according to one embodiment of the present invention using the CFD.

### DETAILED DESCRIPTION OF EXEMPLARY EMBODIMENTS

Hereinafter, exemplary embodiments of the present invention will be described in detail with reference to the accompanying drawings. The embodiments of the present invention are provided to more completely describe the present invention to those skilled in the art, the embodiments described below will be changed into various different forms, and the scope of the present invention is not limited to the following embodiments. Further, the embodiments are provided to make the present invention more solid and complete and to convey the spirit of the present invention to those skilled in the art.

In addition, in the following drawings, thicknesses or sizes of layers are exaggerated for convenience and clarity of the description, and components that are the same are referred to by the same reference numerals. As used in the present specification, the term “and/or” includes any and all combinations of the corresponding listed items. In addition, in the present specification, the term “connected” means a case in which not only an A member and a B member are directly connected but also a case in which an A member and a B member are indirectly connected with a C member interposed between the A member and the B member. Terms used in the present specification are used only to describe the specific embodiments and are not to limit the present invention. Unless the context clearly indicates otherwise, the singular forms described in the specification include the plural forms. In addition, the terms “comprise,” “include,” “comprising,” and/or “including” used in the present specification specify the presence of stated shapes, numbers, steps, operations, members, elements, and/or groups thereof but do not preclude the presence or addition of one or more other shapes, numbers, operations, members, elements, and/or groups thereof.

It is clear that, although the terms “first,” “second,” etc. may be used in the present specification to describe various members, components, regions, layers, and/or portions, these members, components, regions, layers, and/or portions are not to be limited by these terms. These terms are only used to distinguish one member, component, region, layer, or portion from another member, component, region, layer, or portion. Accordingly, a first member, component, region, layer, or portion could be termed a second member, component, region, layer, or portion without departing from the description of the present invention.

The spatially relative terms “beneath,” “below,” “lower,” “above,” and “upper” may be used for facilitating understanding of one component or feature and another component or feature illustrated in a drawing. Such spatially relative terms are for facilitating understanding of the present invention according to various process states or use states of the present invention and are not for limiting the present invention. For example, when a component or feature in a drawing is reversed, the component or feature described with “below” or “beneath” becomes the component or feature described with “on” or “above.” Accordingly, “beneath” has a concept that encompasses “above” or “beneath.”

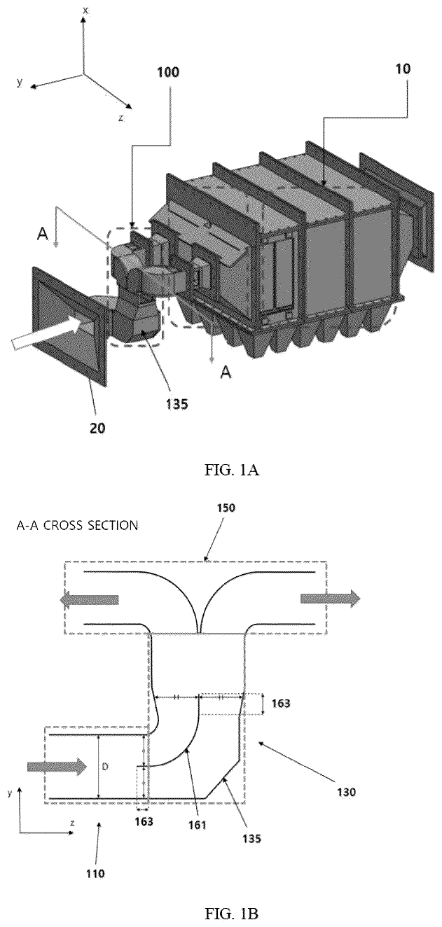

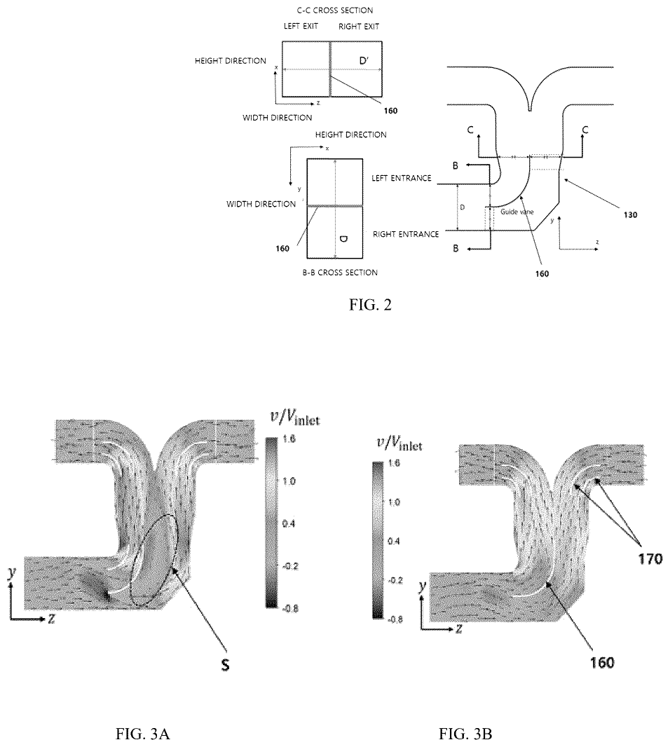

FIG. 1A is a conceptual view illustrating a precipitator to which a duct structure having a guide vane according to one embodiment of the present invention is applied, and FIG. 1B is a cross-sectional view illustrating the duct structure including the guide vane according to one embodiment of the present invention along line A-A in FIG. 1A. FIG. 2 is a cross-sectional view along line B-B and line C-C in FIG. 1B. FIG. 3A shows experimental data obtained by analyzing a flow in a duct structure according to a comparative example using computational fluid dynamics (CFD), and FIG. 3B shows experimental data obtained by analyzing a flow in the duct structure according to a shape of the guide vane according to one embodiment of the present invention using the CFD. Hereinafter, the duct structure including the guide vane according one embodiment of the present invention will be described.

A duct structure 100 having a guide vane according to the present invention is, for example, mounted to communicate with an electrostatic precipitator 10, suctions exhaust gas discharged from a power generation apparatus, and allows the exhaust gas to flow therein to guide the exhaust gas into the electrostatic precipitator 10 and includes an inlet part 110, a duct body 130, and a discharge part 150.

The inlet part 110 is a part through which the exhaust gas discharged from the power generation apparatus is suctioned and has a duct structure in which a flow path is provided. As illustrated in FIG. 1A, a suction hopper 20 may be installed on a front end of the inlet part 110 to come into contact with a maximum amount of exhaust gas so that a large amount of gas is introduced therethough, and the exhaust gas introduced through the suction hopper 20 enters the duct body 130 through the inlet part 110. In this case, as illustrated in the drawings, since the inlet part 110 has a bent portion at which a direction of the flow path changes perpendicularly, a flow direction of the exhaust gas introduced through the suction hopper 20 changes once just after the exhaust gas is introduced. An arrow marked at the inlet part 110 of FIG. 1B denotes the flow direction of the exhaust gas after the flow direction has changed once. For reference, a cross section of the inlet part 110 may be designed in a quadrangular shape as illustrated in the drawings. Hereinafter, based on an inflow direction of the exhaust gas, a left-right direction is referred to as a width direction, and a vertical direction is referred to as a height direction. In FIG. 1B, an inlet has a width D.

Meanwhile, the duct body 130 is a duct structure which extends from the inlet part 110 and guides a flow of the exhaust gas and includes at least one curved portion 135. The exhaust gas which enters through the inlet passes through the duct body 130, and the flow direction of the exhaust gas is changed once by the curved portion 135. That is, according to the structure illustrated in FIG. 1A, a flow in a z-direction changes to an x-direction while the flow passes through the curved portion 135.

Meanwhile, the discharge part 150 may extend from the duct body 130 and may be connected to the electrostatic precipitator 10. In addition, the discharge part 150 may branch off into two sections from the duct body 130, and the two parts may extend and may be connected to the electrostatic precipitator 10. That is, the discharge part 150 may be formed as a pair of discharge ducts, and the discharge ducts may be branched off from the duct body 130 in the z-direction into different sections (in FIG. 1B, a left section and right section) and curved at the discharge ducts in a y-direction to communicate with the electrostatic precipitator 10.

Meanwhile, according to the present invention, as illustrated in FIG. 1B, the duct body 130 includes the curved portion 135 (a curved duct or curved pipe). However, the presence of the curved portion 135 causes phenomena such as generation of a recirculation region, flow separation, and pressure drop. That is, the exhaust gas introduced along the inlet part 110 has inertia along an orientation of the inlet, and when the exhaust gas meets the curved portion 135 of the duct body 130, a phenomenon in which a flow speed of the exhaust gas dramatically decreases and a flow amount is biased to a corner of the curved portion 135 occurs. In addition, this causes generation of a recirculation region S and flow separation, and pressure drop.

In addition, according to the present invention, a curved region is also present in the discharge part 150. That is, since the discharge part 150 has a structure branching off into the pair of discharge ducts, the curved region is present at a branch point. In addition, the curved region causes flow speed reduction and bias in a flow amount according to the above-described principle, and causes phenomena such as generation of the recirculation region S (that is, a reverse flow), flow separation, and pressure drop.

The speed reduction and bias in a flow amount mean that a distribution of a flow amount in the duct structure 100 is not uniform, and the nonuniformity of the flow amount means that a particle distribution of the exhaust gas is not uniform. However, when the particle distribution is nonuniform and the exhaust gas is discharged from the discharge part 150 to the electrostatic precipitator 10, the efficiency with which dust sticks to a precipitator plate is greatly reduced.

In this situation, in the duct structure according to the present invention, a first guide vane 160 and a second guide vane 170 are installed in the duct body 130. The first guide vane 160 is disposed in a region close to the inlet part 110 in the duct body 130 to guide an inflow direction of the exhaust gas, and the second guide vane 170 is disposed in a region close to the discharge part 150 in the duct body 130 to guide a discharge direction of the exhaust gas.

In addition, particularly, the present invention has features of the arrangement and shape of the first guide vane 160. That is, due to the features of the arrangement and shape of the first guide vane 160, when the exhaust gas passes through the curved portion 135, bias in a flow is eliminated to some extent. That is, the first guide vane 160 is used to intentionally guide a flow of a fluid by providing forcibleness to a flow direction of a fluid. Hereinafter, this will be described in detail.

FIG. 1B is the cross-sectional view along line A-A of FIG. 1A. In FIG. 1B, although the first guide vane 160 is illustrated using one line, the first guide vane 160 is disposed perpendicularly to a width direction z of the duct body 130 and is in contact with two inner surfaces of the duct body 130 facing in a height direction (along an x axis). In addition, the first guide vane 160 extends toward an inner portion of the duct body 130 and divides the curved portion 135 into both sides in the width direction. In addition, the first guide vane 160 may include a curved vane 161 curved along an orientation of the curved portion 135 and a straight vane 163 straightly extending from a front end or rear end of the curved vane 161.

The first guide vane 160 having the above-described shape is located between ⅕D in a left direction and ⅕D in a right direction from a center of the duct body 130 in the width direction, the first guide vane 160 divides an area of the inlet into two areas, and thus the exhaust gas suctioned through the inlet part 110 is divided into two flows, that is, a left side flow and a right side flow in the width direction, by the first guide vane 160 and introduced the duct body 130.

First, according to one embodiment of the present invention, the first guide vane 160 is disposed within a predetermined range in a central portion of the duct body 130 in the width direction to divide an entrance area and an exit area to be the same. Specifically, a front end of the first guide vane 160 may be disposed to be located at the center of the inlet part 110 in the width direction so that distances to both inner walls of the inlet part 110 in the width direction are the same, and a rear end may be disposed to be located in the center of the duct body 130 in the width direction so that distances to both inner walls of the duct body 130 in the width direction are the same. In addition, a difference between the entrance area and the exit area is designed to be eliminated or minimized. Alternatively, the first guide vane may be located between ⅕D in the left direction and ⅕D in the right direction from the center of the duct body in the width direction.

Basically, when an exit area for a fluid is greater than an entrance area, a back pressure gradient is generated, which causes a flow separation phenomenon in which the fluid is separated from a surface. In order to solve this problem, the difference between the entrance area and the exit area for the fluid may be minimized as much as possible. According to the present invention, as illustrated in FIG. 2, the exhaust gas branches off at the front end of the first guide vane 160 toward left and right sides in the width direction and is introduced into the first guide vane 160, and after the exhaust gas flows, the exhaust gas passes through the rear end of the first guide vane 160 and merges with the duct body 130. In the first guide vane 160, a left entrance area at the front end and a left exit area at the rear end are the same, or a difference therebetween is minimized, and in the first guide vane 160, a right entrance area at the front end of and a right exit area at the rear end are the same or a difference therebetween is minimized. As one exemplary embodiment, a cross-sectional area (a portion along line B-B in FIG. 2) of the duct body 130 at the inlet part 110 and a cross-sectional area (a portion along line C-C in FIG. 2) of the duct body 130 at the discharge part 150 may be designed to be substantially the same, or a difference therebetween may be designed to be minimized.

According to the above-described arrangement, as two areas of an inflow region through which the exhaust gas enters the first guide vane 160 and two areas of a discharge region through which the exhaust gas is discharged from the first guide vane 160 are divided to be the same, flow separation and the recirculation region S due to a back pressure gradient can be controlled.

Meanwhile, according to the present invention, as the straight vane 163 straightly extending from the front end or rear end of the first guide vane 160 is provided, an eccentric current due to inertia is suppressed to eliminate the recirculation region S and implement a uniform flow.

Basically, when a fluid passes through a bent section, an eccentric current is generated due to an inertia effect. In addition, this causes a nonuniform flow distribution in a duct. In order to solve this, in the present invention, the end of the first guide vane 160 extends straightly to provide straightness to the fluid in a flow direction, thereby suppressing an eccentric current due to an inertia effect. Referring to FIG. 1B, the straight vane 163 is formed on the front end of the first guide vane 160 to extend further toward the inlet part, and the straight vane 163 is formed on the rear end of the first guide vane 160 to extend further toward the discharge part.

Meanwhile, FIGS. 3A and 3B show the experimental data obtained by analyzing the flow in the duct structure including the conventional guide vane and analyzing the flow in the duct structure including the guide vane of the present invention using the CFD according to the shape of the guide vane. FIG. 3A shows the experimental data obtained by analyzing the flow in the duct structure according to the comparative example using the CFD, which is a result of experimenting with a speed distribution in a y-direction when an extension part in a straight shape is not formed on a front end of the guide vane, and FIG. 3B shows a result of experimenting with a speed distribution in the y-direction in the duct structure 100 in which an extension part having a straight shape is formed on the front end of the first guide vane 160 according to one embodiment of the present invention.

Significant pressure drop and a biased flow distribution due to flow separation are clearly shown from the experimental results in FIG. 3A. Accordingly, a recirculation region S due to the flow separation is generated at a rear side of a first guide vane 160 in a flow direction at a central side in a width direction. In contrast, in FIG. 3B, the recirculation region S shown in FIG. 3A is not generated. The following table 1 shows a pressure drop and a flowrate ratio in each case, and referring to table 1, a result in which a pressure drop decreases in the case of FIG. 3B and thus a flow amount distribution is uniform at left and right sides of the guide vane can be seen. According to the experimental result, it can be seen that the pressure drop is reduced by about 50%.

TABLE 1

| | Pressure | Flowrate |
|---|---|---|
| Case | drop [Pa] | ratio |
| 1 | 52.94 | 53.5:46.5 |
| 2 | 26.39 | 50.4:49.6 |

(Case 1: FIG. 3A, Case 2: FIG. 3B)

According to one embodiment of the present invention, a straight length of the straight vane 163 at the front end of the first guide vane 160 may be ½ of the width D of the inlet part 110, and a straight length of the straight vane 163 at the rear end of the first guide vane 160 may be ½ of the width D of the inlet part 110.

In addition, the first guide vane 160 formed as described above may be disposed from the inlet part 110 and the duct body 130 at the inlet part 110, and one first guide vane 160 is present in the duct structure 100.

Meanwhile, the duct structure 100 of the present invention may further include the second guide vane 170. The second guide vane 170 is disposed from the discharge part 150 to the duct body 130 at the discharge part 150, and a pair of second guide vanes 170 are provided in each discharge part 150.

According to one embodiment of the present invention, a first guide vane is installed in a central portion of a duct body in a width direction to divide the duct body into an inflow region and a discharge region such that a difference between an inflow area and a discharge area is eliminated or minimized, thereby suppressing flow separation and generation of a recirculation region due to a back pressure gradient.

In addition, a straight vane is installed to extend from a front end or rear end of the first guide vane to provide straightness in a flow direction to exhaust gas in the duct body to suppress an eccentric current due to an inertia effect, thereby implementing a uniform flow distribution by eliminating a recirculation region around a guide vane.

The above description is merely embodiments for implementing the duct structure including the guide vane according to the present invention, the present invention is not limited to the above-described embodiments, and the technical sprit of the present invention may cover a range in which the embodiment may be variously modified and implemented by anyone skilled in the art without departing from the gist of the present invention defined by the appended claims below.

What is claimed is:

1. A duct structure having a guide vane, comprising:
an inlet part through which exhaust gas discharged form a power generation apparatus is suctioned;
a duct body which extends from the inlet part, guides a flow of the exhaust gas, and includes at least one curved portion; and
a discharge part extending from the duct body and connected to an electrostatic precipitator,
wherein the duct body further includes a first guide vane disposed at the inlet part to guide an inflow direction of the exhaust gas and a second guide vane disposed at the discharge part to guide a discharge direction of the exhaust gas, wherein the first guide vane and the second guide vane are disposed in the duct body.

2. The duct structure of claim 1, wherein the first guide vane includes:
a curved vane curved along an orientation of the curved portion; and
a straight vane extending from a front end or rear end of the curved vane.

3. The duct structure of claim 2, wherein the first guide vane is disposed from the inlet part to the duct body at the inlet part.

4. The duct structure of claim 3, wherein:
a straight length of the straight vane at a front end of the first guide vane is ½ or less of a width (D) of the inlet part; and
a straight length of the straight vane at a rear end of the first guide vane is ½ or less of the width (D) of the inlet part.

5. The duct structure of claim 4, wherein:
the first guide vane is located between ⅕D in a left direction and ⅕D in a right direction from a center of the duct body in a width direction; and
two cross-sectional areas divided from the duct body at the front end of the first guide vane in the width direction and two cross-sectional areas divided from the duct body at the rear end of the first guide vane in the width direction are substantially the same.

6. The duct structure of claim 3, wherein:
the second guide vane is disposed from the discharge part to the duct body at the discharge part; and
the second guide vane is provided as a pair of second guide vanes in each discharge part.
